(19) United States
(12) Patent Application Publication
(10) Pub. No.: US 2015/0320075 A1
(43) Pub. Date: Nov. 12, 2015

(54) COATING COMPOSITIONS FOR CONSUMABLE ARTICLES

(71) Applicant: TATE & LYLE INGREDIENTS AMERICAS LLC, Hoffman Estates, IL (US)

(72) Inventors: Rohit MEDHEKAR, Schaumburg, IL (US); Warren NEHMER, Decatur, IL (US); Lisa TUOHY, Oakland Hills, IL (US); Shawn SPRANKLE, Elgin, IL (US)

(73) Assignee: Tate & Lyle Ingredients Americas LLC, Hoffman Estates, IL (US)

(21) Appl. No.: 14/654,700

(22) PCT Filed: Dec. 20, 2013
(86) PCT No.: PCT/US2013/076805

§ 371 Date: Jun. 22, 2015

Related U.S. Application Data
(60) Provisional application No. 61/740,273, filed on Dec. 20, 2012.

(51) Int. Cl. A23G 3/34; A23L 1/00; A23G 3/42; A23L 1/164

(52) U.S. Cl. CPC A23G 3/343; A23L 1/1641; A23L 1/0047; A23G 3/42; A23V 2002/00

(57) ABSTRACT

coating compositions for consumable articles Compositions comprised of a reduced sugar syrup and a food grade emulsifier/foaming agent are useful for forming opaque coatings on consumable articles.

### FIELD OF THE INVENTION

The present invention relates to compositions useful for forming opaque, reduced sugar, sweet-tasting coatings on consumable articles.

### BACKGROUND OF THE INVENTION

Many food products, such as baked goods and ready-to-eat cereals, include an outer coating which is comprised mostly of sugar. Such coatings may serve multiple purposes, including, for example, providing cereals with longer bowl life, imparting a crispy but non-brittle texture to the food product, and giving the surface of the food product a frosted, opaque appearance that consumers find appealing. Outer coatings of this type additionally provide enhanced sweetness and taste as compared to the uncoated food product, which typically is grain-based and has a relatively low sugar content.

Recently, however, consumers have expressed a desire for sweet-coated food products that have the same sweetness and appearance as conventional sugar-coated products, but with a reduction in the sugar content of such products. A need therefore exists for ways to provide a sweet coating for a food product that has a reduced sugar level while maintaining the bulk, taste and appearance of a traditional full sugar coating. In particular, it has proven difficult to formulate such sweet coatings which when dry have a pleasing opaque appearance, since the crystallization of sugar is generally responsible for providing the desired opacity. As the sugar content is reduced, a coating generally becomes glazed or translucent in appearance, rather than fully opaque. Moreover, ingredients introduced to partially replace sugar can inhibit the crystallization of the sugar which is still present in the coating formulation.

### BRIEF SUMMARY OF THE INVENTION

One aspect of the invention provides composition useful for forming an opaque coating on a consumable article, wherein the composition is comprised of a reduced sugar syrup and a food grade emulsifier/foaming agent.
Another aspect of the invention provides a consumable article coated with the above-mentioned composition.

Still another aspect of the invention provides a method of making a reduced sugar-coated consumable article, comprising forming a coating comprised of the above-mentioned composition on a surface of a consumable article.
Combining the food grade emulsifier/foaming agent with the reduced sugar syrup has been discovered to provide a composition which when coated onto a consumable article results in a sweet-tasting coating which is more opaque (frosted) in appearance than a coating obtained in the absence of the emulsifier/foaming agent.

### DETAILED DESCRIPTION OF THE INVENTION

As used herein, the term “reduced sugar syrup” refers to a mixture of saccharides in water that has a total content of mono- and di-saccharides which is, on a dry solids basis, lower than the content of such saccharides present in conventional sugar syrups such as corn syrups. For example, the reduced sugar syrup may have a total mono- and di-saccharide content that is less than 30%, less than 25%, less than 20% or less than 15% by weight, on a dry solids basis. The total mono- and di-saccharide content may be, for example, at least 5% or at least 10% by weight on a dry solids basis. To help lower the viscosity, the reduced sugar syrup may advantageously have a content of saccharides having a DP (degree of polymerization) greater than 11 of, for example, less than 25%, less than 20%, less than 15%, less than 10%, or less than 5% by weight, on a dry solids basis. In one embodiment, the reduced sugar syrup has a total mono- and di-saccharide content of from 10% to 30% on a dry solids basis and a content of saccharides having a DP greater than 11 of less than 5% on a dry solids basis, with oligosaccharides having a DP of from 3 to 11 making up the balance of the components other than water which are present in the syrup. The reduced sugar syrup may be selected to have a viscosity of less than about 1500 poise at 20° C. as measured at a dry solids content of 80%. The dry solids content of the syrup can be varied as may be desired for different applications, but may in one embodiment be about 65 to about 85%, with the balance being predominantly or exclusively water. The reduced sugar syrup may be combined with the food grade emulsifier/foaming(s) and other components of the coating composition in syrup form. Alternatively, a dried reduced sugar composition may be simultaneously or sequentially combined with water, the food grade emulsifier/foaming(s) and other components to obtain coating compositions in accordance with the present invention.

Reduced sugar syrups suitable for use in the present invention are known in the art and may be prepared by any appropriate method, including for instance the enzyme-catalyzed hydrolysis of starch wherein one or more enzymes are selected which are capable of providing a reduced sugar syrup having the desired characteristics. For example, the reduced sugar syrup may be obtained by heating a corn starch in an aqueous slurry containing an alpha-amylase which is selective to provide a saccharide distribution having a relatively low content (e.g., ≦30% by weight on a dry solids basis) of mono- and di-saccharides, a relatively low content (e.g., ≦15% by weight on a dry solids basis) of polysaccharides (DP>11), and a relatively high content (e.g., ≧60% by weight on a dry solids basis) of oligosaccharides (DP3-DP11). The DE (Dextrose Equivalence) value of the syrup may be from about 25 to about 40, in one embodiment of the invention. Suitable reduced sugar syrups and methods of preparing such reduced sugar syrups are described, for example, in U.S. Pat. Pub. No. 2013/0197104, the disclosure of which is incorporated herein by reference in its entirety for all purposes.

Suitable emulsifiers/foaming agents useful in the present invention include any of the substances approved for, or acceptable for use in, food products that have emulsifying and/or foaming characteristics (i.e., substances that are capable of emulsifying or foaming a composition when included in such composition). Particularly suitable for use in the present invention are modified starches, including lipophilic starches. Lipophilic starches may be prepared by reacting starch with a reagent which introduces lipophilic (hydrophobic) groups such as hydrocarbon chains (e.g., aliphatic groups containing, for example, 4 to 18 carbon atoms, which may be saturated or unsaturated) onto the backbone of a starch molecule through esterification reactions or the like. The resulting modified starch contains both lipophilic and hydrophilic segments. For example, a suitable lipophilic starch may be obtained by reacting starch with an organic acid anhydride such as n-octenyl succinic anhydride or the like. Lipophilic starches are well known in the art and are readily available from commercial sources, including from Tate & Lyle under the brand names MIRAMIST and MIRACAP.

Generally speaking, an amount of food grade emulsifier/foaming agent (which can be either a single emulsifier/foaming agent or a mixture of emulsifiers/foaming agents) is included in the coating composition which is effective to increase the opacity of the coating composition when applied as a coating and dried. Typically, suitable amounts for such purpose are about 0.1 to about 10% by weight of the coating composition.

The coating compositions of the present invention may further comprise, in addition to the reduced sugar syrup and the food grade emulsifier/foaming agent, one or more additional ingredients such as high intensity (high potency) sweeteners (including both natural and synthetic sweeteners, such sweeteners being used in amounts effective to impart the same level of perceived sweetness to the composition as would be present in an analogous composition prepared using a conventional, full sugar syrup), low intensity, non-saccharide sweeteners such as polyols (e.g., sugar alcohols), vitamins, preservatives, stabilizers, pH adjusting agents, colorants, flavors (flavorants), fragrances, triglycerides (oils, fats) and the like. A combination of a reduced sugar syrup and a sugar such as sucrose may be utilized in the coating composition. Thus, for example, the sucrose in a conventional coating composition may be partially (e.g., 10% to 75%) replaced with a reduced sugar syrup as described herein.
The coating compositions of the present invention can be used to coat a wide variety of consumable articles, including various food products, that typically have a sugar coating or icing. Typically, such food products are in solid (dry) form and are grain-based. These products include, but are not limited to, all types of ready to eat cereal (including flaked cereals, puffed cereals, cereal clusters and extruded cereals); granola type products and so called trail mixes; energy bars and granola bars; baked goods such as cookies, cakes, pies, crackers, pastries and muffins; frozen dairy products such as ice cream cakes and ice cream novelties; confectioneries (candy); nuts and other such foods. The coating compositions of the present invention can enhance the white colored frosted (opaque) appearance of the product. The addition of a food grade emulsifier/foaming agent to a reduced sugar syrup helps to improve the opaque appearance of the reduced sugar syrup when applied as a coating to a consumable article and dried. The coating compositions of the present invention may also be used to adhere cereal particles together to form cereal clusters, with the clusters having a frosted appearance.

The coating composition may be applied to the consumable article by any method known in the art. In one embodiment, the coating composition is sprayed onto the consumable article to form a coating. The coating formed may be foamed (i.e., in the form of a foam). The composition can be provided in the form of a slurry or solution that is sprayed through a spray nozzle to coat the consumable article. In other embodiments, the composition is tumbled, extruded, brushed, knife-coated or roller-coated onto a surface of the consumable article. The composition may be heated to a temperature above room temperature during application so as to improve the flow or other characteristics of the composition. The thickness, coverage and pattern of the applied coating may each be varied as desired to meet consumer preferences or manufacturer needs. For example, the coating may fully or only partially cover the surface of the consumable article. The applied coating may be dried to remove sufficient moisture to provide a solid, adherent coating on the consumable article. For example, the layer of coating composition on the consumable article may be dried to a moisture content of 5% by weight or less. Drying may be facilitated or accelerated by any conventional technique, such as heating or induced air flow. Prior to drying, sprinkles, seasonings or other toppings can be applied to the consumable article, on top of the layer of the coating composition. In one embodiment, the components of the coating composition are selected such that when the composition is dried on a consumable article, the surface of the resulting coating is non-tacky at room temperature. In still other embodiments, the present coating compositions can be provided in a discrete or separate package for application to the consumable article by the consumer. For example, the composition can be provided in a form suitable for use as an icing for application to a baked good such as a toaster strudel. In this embodiment, the composition can be disposed within suitable packaging (e.g., fabricated from a moisture barrier flexible packing film fabricated into a pouch) and provided as a component of a kit article comprising the consumable article, the coating composition and instructions for use or application of the coating composition.

### EXAMPLES

Many companies that manufacture ready-to-eat cereals would like to reduce the sugar (mono- and di-saccharide) content of such cereals per serving level from double digit amounts (as expressed in grams, e.g., 11 g/serving) to single digit amounts (for example, 9 g/serving). Typically most of the sugar in the cereal resides in the sugar coating applied to the grain base. In order to reduce the sugars, the sucrose in the coating has to be replaced with a syrup that is low in sugars. A reduced sugar syrup can be used to at least partially replace sucrose in such coatings.

The currently used process for coating a cereal base with sugar can involve the following steps:

1. Mix sugar and water in ratio of 1:2 (67% sucrose+33% water)
2. Heat the syrup until a brix of 82 is obtained;
3. Spray the syrup on to the cereal coating base while tumbling;
4. Immediately dry the coated base in an oven.

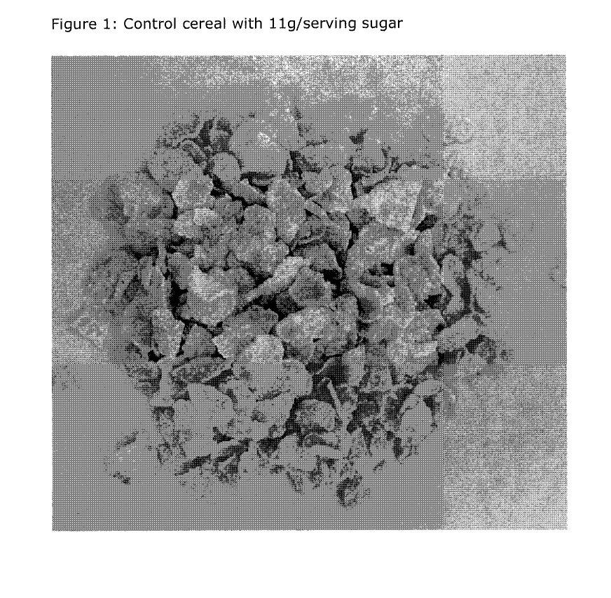

During the drying process the sugar begins to crystallize and give a frosted appearance. A typical final cereal product is pictured in FIG. 1.

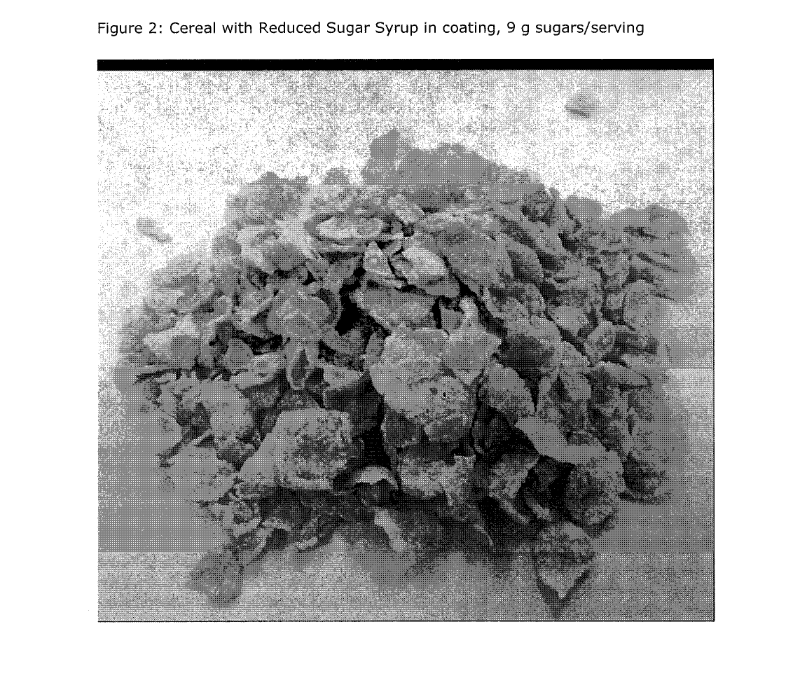

A reduced sugar syrup was substituted for part of the sucrose in the formula so that the total sugar was reduced to 9 grams/serving. The process followed to make the cereal was the same as the control. FIG. 2 is a photograph of the final product, which shows visibly reduced frosted appearance due to the presence of the reduced sugar syrup.

The taste and sweetness for both cereals was within acceptable levels. Only the level of frosting was visibly different.

It was then investigated whether the frosting appearance could be enhanced by addition of a foaming agent/emulsifier. Various foaming agents were tried such as Miramist® 662, Miracap® and Miramist SE® (all modified starches sold by Tate & Lyle). The coating composition for cereal was modified by adding 1% by weight of the above-mentioned emulsifier/foaming agents to the syrup, providing an emulsifier/foaming agent content of 0.4% by weight of the total formula.

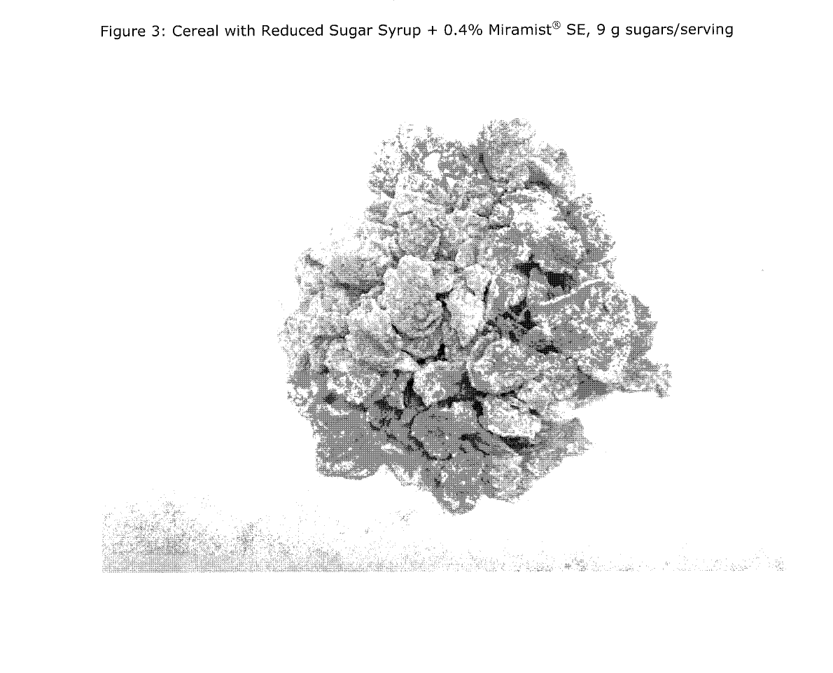

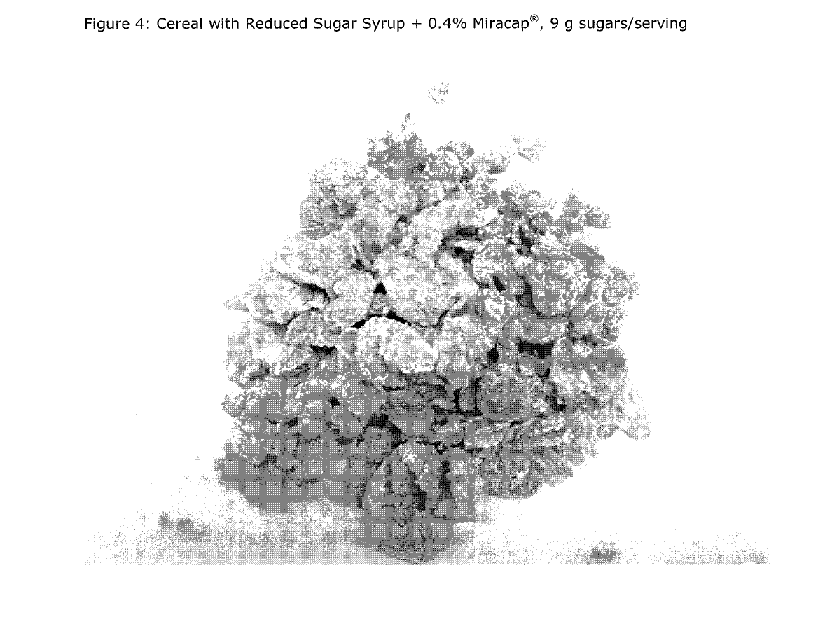

FIGS. 3 and 4 are photographs of the coated cereals obtained using coating compositions containing Miramist® SE and Miracap®.

As may be seen from the Figures, the level of frosting (i.e., degree of opacity of the coating) is significantly increased due to the inclusion of 0.4% of an emulsifier/foaming agent such as Miracap® or Miramist SE®.

1. A composition useful for forming an opaque coating on a consumable article, wherein the composition is comprised of a reduced sugar syrup and a food grade emulsifier/foaming agent.

2. The composition of claim 1, wherein the reduced sugar syrup is comprised of less than about 30% by weight mono- and di-saccharides in total on a dry solids basis.

3. The composition of claim 1, wherein the reduced sugar syrup is comprised of not more than 15% by weight on a dry solids basis of saccharides having a DP value of greater than 11.

4. The composition of claim 1, wherein the food grade emulsifier/foaming agent is a modified starch.

5. The composition of claim 1, wherein the composition comprises from about 0.1 to about 10% by weight of food grade emulsifier/foaming agent.

6. The composition of claim 1, wherein the food grade emulsifier/foaming agent is a lipophilic starch.

7. The composition of claim 1, wherein the food grade emulsifier/foaming agent is a lipophilic starch obtained by reacting starch with n-octenyl succinic anhydride.

8. A consumable article coated with a composition in accordance with claim 1.

9. The consumable article of claim 8, wherein the consumable article is selected from the group consisting of cereals, breakfast bars, granola bars, doughnuts, baked goods, energy bars, trail mixes, granolas, frozen dairy products, and confectioneries.

10. A method of making a reduced sugar-coated consumable article, comprising forming a coating comprised of a composition in accordance with claim 1 on a surface of a consumable article.

11. A composition useful for forming an opaque coating on a consumable article, wherein the composition is comprised of a reduced sugar syrup and a food grade emulsifier/foaming agent, the reduced sugar syrup is comprised of not more than 30% by weight mono- and di-saccharides in total on a dry solids basis and not more than 15% by weight on a dry solids basis of saccharides having a DP value of greater than 11, the food grade emulsifier/foaming agent is a lipophilic starch, and the composition comprises from about 0.1 to about 10% by weight of food grade emulsifier/foaming agent.

12. The composition of claim 11, wherein the composition is additionally comprised of at least one high intensity sweetener.

13. The composition of claim 11, wherein the food grade emulsifier/foaming agent is a lipophilic starch obtained by reacting starch with a reagent which introduces aliphatic groups containing 4 to 18 carbon atoms onto the backbone of the starch.

14. The composition of claim 11, wherein the food grade emulsifier/foaming agent is a lipophilic starch obtained by reacting starch with n-octenyl succinic anhydride.

15. The composition of claim 11, wherein the reduced sugar syrup has a Dextrose Equivalence value of from about 25 to about 40.

16. The composition of claim 11, wherein the reduced sugar syrup has a total mono- and di-saccharide content of from 10% to 30% on a dry solids basis and a content of saccharides having a DP greater than 11 of less than 5% on a dry solids basis, with oligosaccharides having a DP of from 3 to 11 making up the balance of the components other than water which are present in the syrup.

17. The composition of claim 1, wherein the composition is additionally comprised of at least one high intensity sweetener.

18. The composition of claim 1, wherein the food grade emulsifier/foaming agent is a lipophilic starch obtained by reacting starch with a reagent which introduces aliphatic groups containing 4 to 18 carbon atoms onto the backbone of the starch.

19. The composition of claim 1, wherein the reduced sugar syrup has a Dextrose Equivalence value of from about 25 to about 40.

20. The composition of claim 1, wherein the reduced sugar syrup has a total mono- and di-saccharide content of from 10% to 30% on a dry solids basis and a content of saccharides having a DP greater than 11 of less than 5% on a dry solids basis, with oligosaccharides having a DP of from 3 to 11 making up the balance of the components other than water which are present in the syrup.
